(19) United States
(12) Patent Application Publication
(10) Pub. No.: US 2024/0155972 A1
(43) Pub. Date: May 16, 2024

(54) Pneumatic Lawn Level

(71) Applicant: Andrew Brenden Laplante, Mount Laurel, NJ (US)

(72) Inventor: Andrew Brenden Laplante, Mount Laurel, NJ (US)

(21) Appl. No.: 18/375,411

(22) Filed: Sep. 29, 2023

Related U.S. Application Data
(60) Provisional application No. 63/415,677, filed on Nov. 11, 2022.

(51) Int. Cl. A01D 7/00

(52) U.S. Cl. CPC A01D 7/00

(57) ABSTRACT

A pneumatic lawn level may leverage a gas strut which may apply down force to the base of the level to inhibit free motion backward toward the user. This may prevent soil and debris from becoming projectiles as the user moves the level base back and forth in front of them. In addition, the pneumatic lawn level may use the gas strut to provide an auto-retracting feature for storage. Further, addition of the gas strut may provide a joint that may give greater stability to the overall structure of the pneumatic lawn level. Moreover, the pneumatic lawn level may reduce the amount of force and effort needed to level the ground properly due to the gas strut's application of pressure on the level base.

### CROSS REFERENCE TO RELATED APPLICATION

This application claims the benefit under 35 U.S.C. § 119(e) of U.S. Provisional Patent Application Ser. No. 63/415,677 filed on Nov. 11, 2022, entitled “Pneumatic Lawn Level,” which is incorporated by reference in its entirety.

### FIELD OF THE DISCLOSURE

The present disclosure generally relates to leveling in lawns and gardens, and more particularly to a pneumatic lawn level.

### BACKGROUND

A leveling tool may be used to modify substrate deviations in otherwise flat surfaces such as lawns and gardens. Generally, a lawn level may include a handle on the base design with simple adjoining hardware to allow for motion and flexibility to remain parallel with the face of the surface to be leveled.

### SUMMARY

Embodiments of the present disclosure may provide a pneumatic lawn level comprising: a handle having a bottom handle portion and a top handle portion; a gas strut; and a level base. The bottom handle portion and the top handle portion may be attached together through welding a U-joint. The bottom handle portion also may include a through-hole capable of receiving hardware to mount to the handle or to the level base. The through-hole may be positioned approximately 8 inches from the welded U-joint. The handle may be approximately 70 inches in length. The handle may be hollow.

The gas strut may be affixed approximately 12 inches from the level base. The bottom handle portion may have a through-hole that may receive a fastener and provide a mounting point for the gas strut. The fastener may be a stainless steel hex head bolt. A portion of the gas strut fastened to the bottom handle portion may align with a relief channel at a base of the bottom handle. The pneumatic lawn level also may include a tightening mechanism fastened on the fastener to further secure the gas strut to the bottom handle portion. The level base also may include holes to accept at least one fastener that may adjoin the bottom handle portion to the level base. The gas strut may be mounted to a frame of the level base using a fastener. The gas strut may be mounted to the frame of the level base approximately 4 inches from a mounting point of the bottom handle portion to the frame of the level base.

The handle may be manipulated to a 100-degree angle from a starting position when the level base is connected to the handle. A degree of motion may be presented toward a front portion of the level base to avoid abrupt motion or jamming from a front side of the pneumatic lawn level. The gas strut may apply down force to the level base to inhibit free motion backward toward a user. The gas strut may provide an auto-retracting feature for storage. The gas strut may apply pressure on the level base to reduce an amount of force and effort needed to level ground properly.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 depicts a pneumatic lawn level according to an embodiment of the present disclosure; and

FIG. 2 depicts a mechanism to attach a gas strut to the pneumatic lawn level base according to an embodiment of the present disclosure.

### DETAILED DESCRIPTION

A pneumatic lawn level according to embodiments of the present disclosure may leverage a gas strut which may apply down force to the base of the level to inhibit free motion backward toward the user. This may prevent soil and debris from becoming projectiles as the user moves the level base back and forth in front of them. In addition, the pneumatic lawn level according to embodiments of the present disclosure may use the gas strut to provide an auto-retracting feature for storage. The auto-retracting feature is made possible by exerting force from a gas-powered strut attached at the lower handle and the level base, which applies forty-five newtons of distributed force to the level base. Since the gas-powered strut arm is forced to expand outward when not engaged, the level base is forced to return to a dorsal position. Further, addition of the gas strut may provide a joint that may give greater stability to the overall structure of the pneumatic lawn level in embodiments of the present disclosure. Moreover, the pneumatic lawn level according to embodiments of the present disclosure may reduce the amount of force and effort needed to level the ground properly due to the gas strut's application of pressure on the level base.

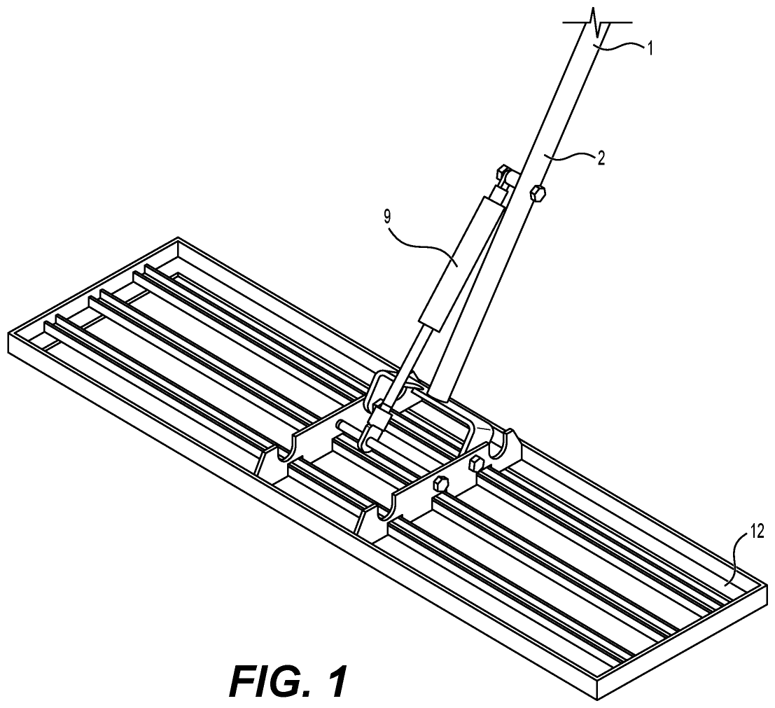

FIG. 1 depicts a pneumatic lawn level according to an embodiment of the present disclosure. A pneumatic lawn level according to an embodiment of the present disclosure may include top handle 1, bottom handle, 2, gas strut 9, and level base 12. The handle may be separated into partitions—top handle 1 and bottom handle 2. Top handle 1 and bottom handle 2 may be attached together through welding a U-joint in an embodiment of the present disclosure; however, it should be appreciated that there may be other embodiments of the present disclosure where other attachment mechanisms may be utilized. Bottom handle 2 may include a ⅜-inch through-hole that may be positioned approximately 8 inches from the welded U-joint in an embodiment of the present disclosure. This through-hole may allow for hardware to be mounted to the handle and/or to level base 12 in embodiments of the present disclosure. In an embodiment of the present disclosure, top handle 1 and bottom handle 2 may be approximately 70 inches in length; however, it may be longer or shorter without departing from the present disclosure. The handle may be steel and may be hollow in an embodiment of the present disclosure; however, other similar materials may be used without departing from the present disclosure. Gas strut 9 may be affixed approximately twelve inches from level base 12 and hardware may be positioned to create an additional joint which can retract and contract for functionality. Level base 12 may be approximately 36 inches in an embodiment of the present disclosure not including the handle or any associated hardware. However, it should be appreciated that level base 12 may be larger or smaller in embodiments of the present disclosure.

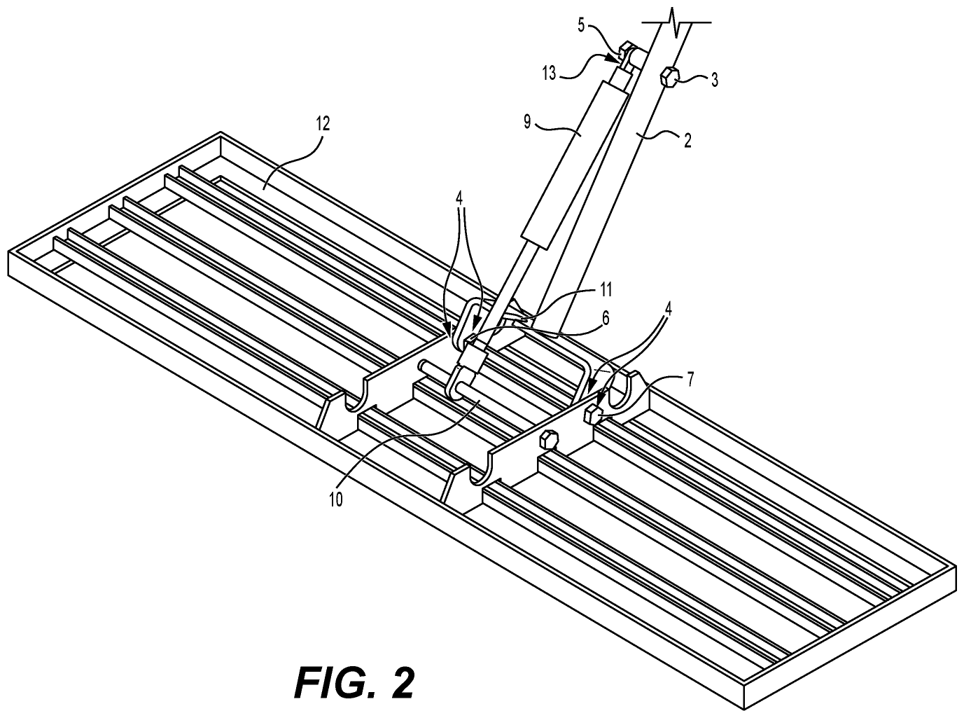

FIG. 2 depicts a mechanism to attach a gas strut to level base 12 of FIG. 1 according to an embodiment of the present disclosure. Fastener 3 may be inserted through the through-hole of bottom handle 2 to provide a mounting point for gas strut 9. In an embodiment of the present disclosure, fastener 3 may be a 2.5-inch stainless steel hex head bolt; however, it should be appreciated that other fasteners of different materials and types may be utilized without departing from the present disclosure. Further, it should be appreciated that if the through-hole is of a larger or smaller size than the ⅜-inch diameter described herein, fastener 3 may be selected to provide for a similar size in embodiments of the present disclosure. Gas strut 9 may be attached to fastener 3 by sliding the shorter end having an eyelet onto threads of fastener 3 which may ensure that it aligns with relief channel 11 at the base of bottom handle 2. Tightening mechanism 5 may be fastened on the remaining threads of fastener 3 to secure gas strut 9 to bottom handle 2. In an embodiment of the present disclosure, tightening mechanism 5 may be a nut; however, there may be embodiments of the present disclosure where a different tightening mechanism may be used, for example, if a different fastener is used. There also may be embodiments of the present disclosure where no separate tightening mechanism is used, such as when the tightening mechanism is incorporated as part of fastener 3.

Bottom handle 2 may be aligned with holes located on the frame of level base 12 so that the U-joint may accept fasteners 7. In an embodiment of the present disclosure, fasteners 7 may be two 1.25-inch stainless steel hex head bolts when the holes on the frame are ⅜-inch in size; however, it should be appreciated that other fasteners may be used to attach with the U-joint without departing from the present disclosure. It also should be appreciated that the fasteners may be formed of materials other than stainless steel without departing from the present disclosure. It may further be appreciated that the size of fasteners 7 may differ depending on the size of the holes located on the located of level base 12 to which they are affixed. Fasteners 7 may adjoin bottom handle 2 to level base 12. Washers 4 and nylon lock nut 6 may be utilized so that the handle can control level base 12. Washers 4 may be located on either end of nylon lock nut 6 in an embodiment of the present disclosure.

Gas strut 9 may be mounted to the frame of level base 12 using fastener 10 according to an embodiment of the present disclosure. Fastener 10 may be a 6-inch stainless steel hex head bolt in an embodiment of the present disclosure; however, it should be appreciated that other fasteners and materials other than stainless steel may be used without departing from the present disclosure. It also should be appreciated that fastener 10 may mount to the frame of level base 12 through ⅜-inch holes on each side of the frame in an embodiment of the present disclosure; however, the size of fastener 10 may vary depending on the size of the holes on each side of the frame in other embodiments of the present disclosure. In an embodiment of the present disclosure, the holes on either side of the frame may be positioned approximately 4 inches from the mounting point of bottom handle 2 on the frame of level base 12. However, the positioning of the holes may vary without departing from the present disclosure.

Eyelet 13 on gas strut 9 opposite the end of gas strut 9 that is attached to bottom handle 2 may slide over the threads of fastener 10 as it passes through the holes on each side of the frame of level base 12. Once joined together, nylon lock nut 6 may be used to secure additional hardware (i.e., nylon lock nuts, washers) to the frame of level base 12, such as to continue assembly.

After level base 12 is connected to the handle, the handle may be manipulated to a 100-degree angle from a starting position in embodiments of the present disclosure. The degree of motion may be presented toward the front of level base 12 to avoid abrupt motion or jamming from the front side of the pneumatic lawn level in embodiments of the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A pneumatic lawn level comprising:
a handle having a bottom handle portion and a top handle portion;
a gas strut; and
a level base.

2. The pneumatic lawn level of claim 1, wherein the bottom handle portion and the top handle portion are attached together through welding a U-joint.

3. The pneumatic lawn level of claim 2, the bottom handle portion further comprising:
a through-hole capable of receiving hardware to mount to the handle or to the level base.

4. The pneumatic lawn level of claim 3, wherein the through-hole is positioned approximately 8 inches from the welded U-joint.

5. The pneumatic lawn level of claim 1, wherein the handle is approximately 70 inches in length.

6. The pneumatic lawn level of claim 1, wherein the handle is hollow.

7. The pneumatic lawn level of claim 1, wherein the gas strut is affixed approximately 12 inches from the level base.

8. The pneumatic lawn level of claim 1, wherein the bottom handle portion has a through-hole that receives a fastener and provides a mounting point for the gas strut.

9. The pneumatic lawn level of claim 8, wherein the fastener is a stainless steel hex head bolt.

10. The pneumatic lawn level of claim 8, wherein a portion of the gas strut fastened to the bottom handle portion aligns with a relief channel at a base of the bottom handle.

11. The pneumatic lawn level of claim 8 further comprising:
a tightening mechanism fastened on the fastener to further secure the gas strut to the bottom handle portion.

12. The pneumatic lawn level of claim 1, the level base further comprising:
holes to accept at least one fastener that adjoins the bottom handle portion to the level base.

13. The pneumatic lawn level of claim 1, wherein the gas strut is mounted to a frame of the level base using a fastener.

14. The pneumatic lawn level of claim 13, wherein the gas strut is mounted to the frame of the level base approximately 4 inches from a mounting point of the bottom handle portion to the frame of the level base.

15. The pneumatic lawn level of claim 1, wherein the handle is manipulated to a 100-degree angle from a starting position when the level base is connected to the handle.

16. The pneumatic lawn level of claim 15, wherein a degree of motion is presented toward a front portion of the level base to avoid abrupt motion or jamming from a front side of the pneumatic lawn level.

17. The pneumatic lawn level of claim 1, wherein the gas strut applies down force to the level base to inhibit free motion backward toward a user.

18. The pneumatic lawn level of claim 1, wherein the gas strut provides an auto-retracting feature for storage.

19. The pneumatic lawn level of claim 1, wherein the gas strut applies pressure on the level base to reduce an amount of force and effort needed to level ground properly.
